(19) United States
(12) Patent Application Publication
(10) Pub. No.: US 2010/0268859 A1
(43) Pub. Date: Oct. 21, 2010

(54) Server

(75) Inventor: Mario John Dominic Lee, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: HON HAI Precision Industry CO., LTD., Tu-Cheng City (TW)

(21) Appl. No.: 12/455,057

(22) Filed: May 28, 2009

(30) Foreign Application Priority Data
Apr. 16, 2009 (CN) 200910301589.8

(51) Int. Cl. G06F 13/00

(52) U.S. Cl. 710/104

(57) ABSTRACT

A server includes a motherboard, a central processing unit (CPU) and a riser card. The CPU is mounted on the motherboard. The riser card is inserted in the motherboard. The riser card includes a first circuit board extending parallel to the CPU, such that the CPU positioned between the motherboard and the first circuit board. At least one memory is inserted in the first circuit board.

### BACKGROUND

1. Technical Field

The disclosure relates to a server and, particularly, to a high performance server.

2. Description of Related Art

Traditional servers usually have many hard disk drives, but limited central processing units (CPU), memory and I/O capacity. Current servers have high performance with many CPU sockets and large memory size, but limited I/O capacity and hard disk drive due to constraint of the size of the server.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a top view of a server;

FIG. 2 is a main view of a server; and

FIG. 3 is a side view of a server.

### DETAILED DESCRIPTION

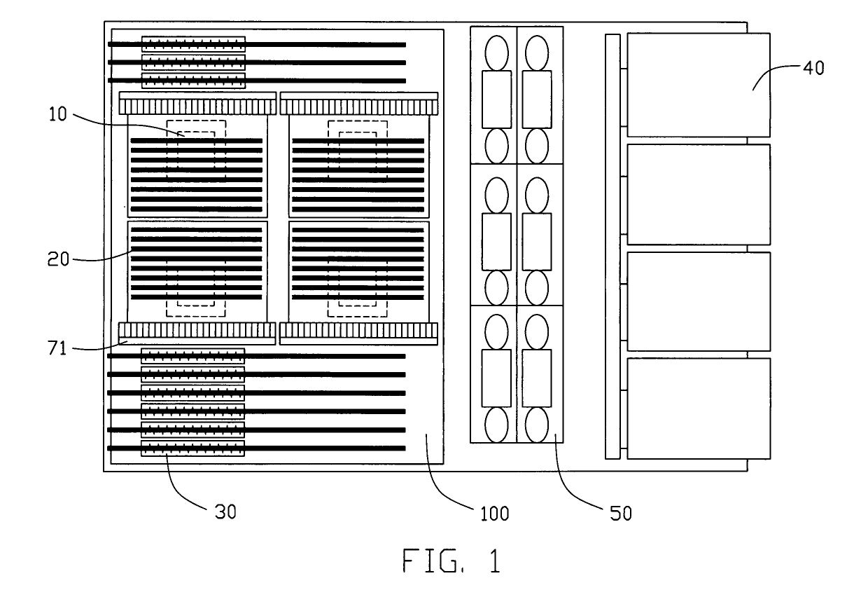

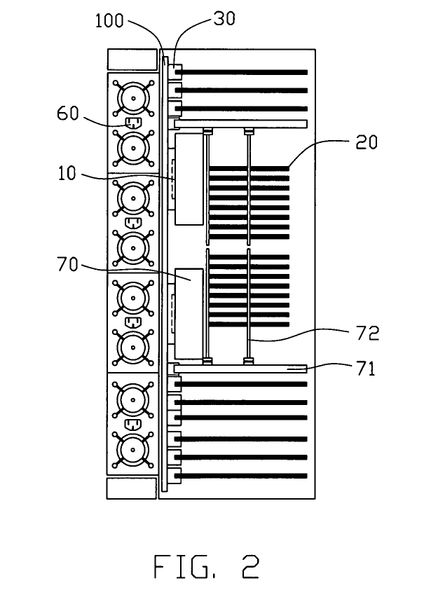

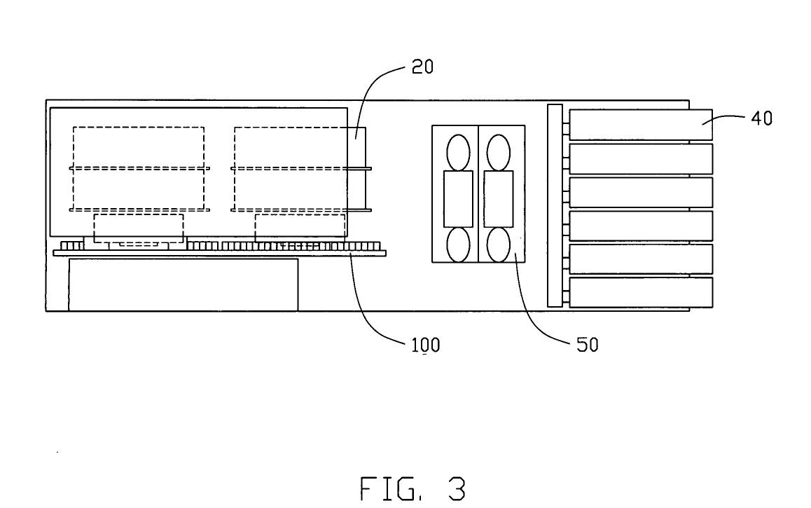

Referring to FIG. 1, FIG. 2 and FIG. 3, a server includes a plurality of central processing units (CPU) 10, a plurality of memories 20, a plurality of peripheral component interconnect express (PCIE) slots 30, a plurality of hard disk drives 40, a plurality of fans 50, a plurality of power supplies 60, and a plurality of heat sinks 70. The CPUs 10 are mounted in corresponding CPU sockets. The memories 20 are inserted in corresponding memory sockets. The PCIE slots 30 are capable of receiving corresponding PCIE cards. The hard disk drives 40 are configured for storing data. The fans 50 are used for dissipating heat in the server. The power supplies 60 supply power to the server. The heat sinks 70 are capable of dissipating heat from the CPUs 10.

The CPUs 10 and the PCIE slots 30 are installed on a motherboard 100. The CPUs 10 are approximately set in the middle of the motherboard 100. Each heat sink 70 is fixed on top of the CPU 10 to dissipate heat from the CPU 10. The PCIE slots 30 are set at two sides of the CPUs 10 on the motherboard 100. Each PCIE slot 30 is used for connecting with a PCIE card.

A plurality of riser cards 71 is generally vertically installed on the motherboard 100 adjacent to the heat sinks 70. Each riser card 71 includes two parallel circuit boards 72 spaced enough apart to accommodate memories 20. A distance between two circuit boards 72 is greater than a height of the memory 20. The riser card 71 is generally oriented parallel to the PCIE card. The memories 20 are generally perpendicular to the motherboard 100 and parallel to the riser card 71. The circuit boards 72 and the memories 20 are laid on the top of the heat sinks 70.

The plurality of power supplies 60 are fixed under the CPUs 10 in the server. The plurality of hard disk drives 40 are fixed away from the CPUs 10 in the server. The plurality of fans 50 are mounted between the motherboard 100 and the hard disk drives 40.

The server can have four rack units (4 U). In one embodiment, one rack unit (1 U) is 1.75 inches (44.45 mm) high. The server may have other components therein but are not shown. The riser cards 71 are plugged in a side of the CPUs 10. The riser cards 71 include two parallel circuit boards 72. The memories 20 are inserted in the circuit boards 72. The PCIE slots 30 are set at a side of the riser cards 71. The hard disk drives 40 are positioned away from the CPUs 10. The fans 50 are mounted between the CPUs 10 and the hard disk drives 40. The power supplies 60 are set under the motherboard 100 opposite to the CPUs 10. The heat sinks 70 are fixed on the top of the CPUs 10. With this arrangement of components the server can hold more CPUs, more memories, and more hard disk drives without having to enlarge overall size of the server when compared to typical servers' setup. This provides a great utility to the function of the server.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A server comprising:
a motherboard;
a central processing unit (CPU) mounted on the motherboard; and
a riser card inserted in the motherboard, the riser card comprising a first circuit board extending parallel to the CPU such that the CPU positioned between the motherboard and the first circuit board, and at least one memory inserted in the first circuit board.

2. The server of claim 1, wherein the at least one memory is located directly above the CPU.

3. The server of claim 1, wherein a plurality of peripheral component interconnect express slots are arranged on the motherboard adjacent to the CPU.

4. The server of claim 1, wherein the riser card is generally perpendicular to the motherboard.

5. The server of claim 1, wherein the first circuit board and the riser card are generally perpendicular to each other.

6. The server of claim 1, wherein the at least one memory is generally perpendicular to the motherboard and parallel to the riser card.

7. The server of claim 1, wherein the riser card further comprises a second circuit board parallel to the first circuit board, a distance between the first and second circuit board is greater than a height of the at least one memory.

8. The server of claim 1, wherein a heat sink is fixed between the CPU and the at least one memory.

9. The server of claim 1, further comprising a plurality of hard disks.

10. The server of claim 9, wherein a plurality of fans is fixed between the CPU and the hard disks.

11. A server comprising:
an enclosure;
a motherboard received in the enclosure;
a plurality of memories, wherein the memories are coupled to the motherboard through a riser card; and
a central processing unit (CPU) being arranged between the motherboard and the memories, the memories are located above the CPU.

12. The server of claim 11, wherein a plurality of peripheral component interconnect express slots are arranged on the motherboard adjacent to the CPU.

13. The server of claim 11, wherein the riser card is generally inserted perpendicular to the motherboard.

14. The server of claim 11, wherein the riser card comprises a first circuit board for securing the memories.

15. The server of claim 14, wherein a second circuit board is inserted in the riser card and parallel to the first circuit board, a distance between the first and second circuit board is greater than a height of each memory.

16. The server of claim 11, wherein each memory is generally perpendicular to the motherboard and parallel to the riser card.

17. The server of claim 11, wherein a heat sink is fixed between the CPU and the memory.

18. The server of claim 11, further comprising a plurality of hard disks.

19. The server of claim 18, wherein a plurality of fans is fixed between the CPU and the hard disks.

20. The server of claim 11, wherein a plurality of power supplies is located under the CPU.
